(19) United States
(12) Patent Application Publication
(10) Pub. No.: US 2016/0239753 A1
(43) Pub. Date: Aug. 18, 2016

(54) METHOD AND SYSTEM FOR RATING MEASURED VALUES TAKEN FROM A SYSTEM

(71) Applicant: DEUTSCHE TELEKOM AG, Bonn (DE)

(72) Inventors: Bernhard Loehlein, Erlenbach (DE); Mehran Roshandel, Berlin (DE); Hamed Ketabdar, Berlin (DE); Martin Schuessler, Moeser (DE); Tajik Shahin, Berlin (DE)

(21) Appl. No.: 15/024,365

(22) PCT Filed: Aug. 13, 2014
(86) PCT No.: PCT/EP2014/067352

§ 371 Date: Mar. 24, 2016

(30) Foreign Application Priority Data
Sep. 27, 2013 (EP) 13186464.7

(51) Int. Cl. G06N 7/00; G06F 11/07; G06N 99/00

(52) U.S. Cl. CPC G06N 7/005; G06N 99/005; G06F 11/079; G06F 11/0721

(57) ABSTRACT

A method for rating measured values taken from a system S that may be in an error-free or erroneous state, includes: forming, by a device, a set V of unmarked measured values v from the system S; forming, by the device, a modified learning set V′ comprising measured values v′ for a learning system L by removal or weighting or removal and weighting of measured values from the set V using a random-based method; forming, by the device, a model M for rating measured values from the system S by the learning system L from the modified learning set V′; and rating, by the device, measured values from the system S by a rating system B using the model M. At least one closest neighbor of the measured value v is removed during removal or weighting or removal and weighting of measured values v from the set V.

### CROSS-REFERENCE TO RELATED APPLICATIONS

This application is a U.S. National Phase application under 35 U.S.C. §371 of International Application No. PCT/EP2014/067352, filed on Aug. 13, 2014, and claims benefit to European Patent Application No. EP 13186464.7, filed on Sep. 27, 2013. The International Application was published in German on Apr. 2, 2015 as WO 2015/043823 A1 under PCT Article 21(2).

### FIELD

The present invention relates to a method and a system for rating measured values taken from a system S that may be in an error-free or an erroneous state. The system comprises at least one communication network, a network component of a communication system and/or a service of a communication network.

### BACKGROUND

In the field of detecting abnormal or non-normal measured values, so-called outliers, the prior art comprises numerous methods for finding abnormal or non-normal measured values. Finding non-normal measured values is referred to as “outlier detection” or also “anomaly detection”.

For example, in [1] the use of outlier detection is described as one of the main steps in the field of data mining. In [1], particular attention is drawn to robustness of the used estimation, and various possibilities of outlier detection based on distance measurements, cluster methods as well as spatial methods are shown.

In [2], the meaning of outlier detection is discussed as an important problem for various fields of applications as well as scientific fields.

The outlier detection methods known from the prior art first of all differ in view of the basic assumptions and requirements. For outlier detection, some methods require the underlying distributions and their parameters by means of which a system S generates the measured values. Moreover, there are methods which calculate by means of a “Local Outlier Probability Algorithm” (LoOP, [3]) a probability value in connection with a “Local Outlier Factor Algorithm” (LOF, [4]) or related algorithms.

Moreover, [5] discloses a method for obtaining a transformation relating to probability values, i.e. values in an interval of [0, 1], on the basis of score values as output of any desired score function for outlier detection. This probability value indicates the probability that a measured value from a set V is an outlier with respect to the underlying set of measured values. The probabilities are used for making a list comprising very probable outliers.

The publication [6] relates to a system and a method for data filtering for reducing functional and trend-line outlier bias.

In conventional methods for detecting outliers, normally threshold values or limiting values are used. For example, it is possible to detect that above or below such a threshold value or limiting value, a measured value can be considered to be an outlier or a normal measured value.

The use of threshold values is disadvantageous in that such threshold values must mostly be detected by means of involved tests and evaluations. Moreover, measured values from the set V which deviate very much from the majority of the measured values but belong to a normal system state of S will be filtered out by the use of a threshold value without the possibility of also entering them into a learning set in accordance with an assigned probability for determining the state of a system.

### REFERENCES

[1] Irad Ben-Gal. “Outlier detection”, in: Maimon O. and Rockach L. (Eds.), “Data Mining and Knowledge Discovery Handbook: A Complete Guide for Practitioners and Researchers” Kluwer Academic Publishers, 2005
[2] Varun Chandola, Arindam Banerjee, Vipin Kumar. “Outlier Detection: A Survey”, 2007, (http://citeseerx.ist.psu.edu/viewdoc/summary?doi=10.1.1.108.8502)
[3] Hans-Peter Kriegel, P. Kröger, E. Schubert, A. Zimek. “LoOP: Local Outlier Probabilities”, in Proceedings of 18th ACM Conference on Information and Knowledge Management (CIKM), 2009 (http://www.dbs.ifi.lmu.de/Publikationen/Papers/LoOP1649.pdf).
[4] M. M. Breunig, Hans-Peter Kriegel, R. T. Ng, J. Sander. “LOF: Identifying Density-based Local Outliers”, in ACM SIGMOD Record. No. 29, 2000, (http://www.dbs.ifi.lmu.de/Publikationen/Papers/LOF.pdf)
[5] Hans-Peter Kriegel, Peer Kroger, Erich Schubert, Arthur Zimek. “Interpreting and Unifying Outlier Scores”, in Proceedings of 11th SIAM International Conference on Data Mining. 2011, (http://siam.omnibooksonline.com/2011datamining/data/papers/018.pdf).
[6] US 2013/046727 A1

### SUMMARY

In an embodiment, the invention provides a method for rating measured values taken from a system S that may be in an error-free or erroneous state. The system S comprises at least one communication network, a network component of a communication system or a service of a communication network. The method includes: (a) forming, by a device, a set V of unmarked measured values v from the system S; (b) forming, by the device, a modified learning set V′ comprising measured values v′ for a learning system L by (i) removal or (ii) weighting or (iii) removal and weighting of measured values from the set V using a random-based method; (c) forming, by the device, a model M for rating measured values from the system S by the learning system L from the modified learning set V′; and (d) rating, by the device, measured values from the system S by a rating system B using the model M. Step (b) further includes removing at least one closest neighbor of the measured value v during (i) removal or (ii) weighting or (iii) removal and weighting of measured values v from the set V.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a schematic view of a method for rating measured values taken from a system according to a conventional method of the prior art,

FIG. 2 shows a schematic view of a preferred embodiment of a method for rating measured values taken from a system according to the present invention,

FIG. 3 shows a schematic view of a preferred embodiment of a system for rating measured values taken from a system S according to the present invention, and

FIG. 4 shows a schematic view of a Weibull distribution, which is used as transfer function, of a preferred embodiment of a method for rating measured values taken from a system according to the present invention.

### DETAILED DESCRIPTION

In an embodiment, the invention provides a method and a system for rating measured values taken from a system S that may be in an error-free/normal or erroneous/non-normal state.

The invention starts out from the basic idea that a preferably machine or statistic learning system L can rate measured values in an automated manner on the basis of unmarked measured values V from a system S to be monitored. The non-normal measured values can indicate that the system S is in an erroneous state. Unmarked means that in view of the measured value there is no information in which state—error-free/erroneous—the system S was at the time the measured value was taken.

A randomized/random-based method is provided which removes, prior to the use of a learning system, the measured values from a learning set V of measured values which very probably result from an erroneous state of a system S. Thus, it is prevented that such measured values influence the learning process of the learning system L negatively to the effect that the learned model M erroneously rates an erroneous state of the system S as being normal when rating future, new measured values W. On the other hand, it is accounted for the finding that such values are valuable for the learning process of a learning system and, if possible, should not be removed (completely). In this connection, the invention takes into account that V can comprise measured values which have an extraordinary value as compared to the other measured values in V, but which have not been detected in an erroneous state of the system S and, therefore, should be considered as being normal.

The invention relates to a method for rating measured values taken from a system S that may be in an error-free/normal or erroneous/non-normal state, wherein the system S comprises at least one communication network, a network component of a communication system and/or a service of a communication network, comprising the following steps, preferably in the following order: (a) forming a set V of unmarked measured values v from the system S; (b) forming a modified learning set V′ comprising measured values v′ for a learning system L by removal and/or weighting of measured values from the set V using a random-based method; (c) forming a model M for rating measured values from the system S by the learning system L from the modified learning set V′; and (d) rating measured values from the system S by a rating system B using the model M.

The system S can be a system with two system states—error-free/normal and erroneous/non-normal. However, the method can also be applied to other systems S which have different system states, for example a plurality of system states.

According to the invention, it is not necessary that trustworthy information as to whether or not the respective measured value was measured at a time at which the system S was in an erroneous state or in an error-free state is present in view of the unmarked measured values v of the system S. The measured values are taken at the measuring system S and can be indicators of the system state. In case different types of measured values are present, also information about the type of the measured value can be assigned to the respective measured value. In case the measured values are time series, information about the time point of the measurement can additionally be assigned to the set V for the individual measured values v.

According to an embodiment of the invention, step (b) comprises the following steps, preferably in the following order: (b1) forming a score value set Q comprising score values q from the set V by at least one score function F: V→Q, v [symbol] F(v)=q; (b2) forming a probability set P comprising probabilities p from the score value set Q by at least one transformation function T: Q→P, q [symbol] T(q)=T(F(v))=p; (b3) forming the modified learning set V′ of measured values, wherein the measured values v G V are included with a respective probability of 1−p, with p=T(F(v)), into the modified learning set V′ and/or wherein the measured values v∈V are given a respective weighting by at least one weighting function G.

The score function F can form a score value for each individual measured value from the set V or for a sub-set of measured values—for example in case of measured values of different types of measured values at a time point or a certain instance—from the learning set V. Without restriction of generality, the score value can be a real number. For example, a low score value can be associated with an error-free measured value and a high score value can be associated with an erroneous measured value.

The transformation function T can assign to a score value, for example a real number, a probability value, for example a real number in the interval of [0, 1], For example, a measured value v with T(v)=0 cannot be removed from the set V with a probability 0, i.e. can be safely transferred to or remain in a modified learning set V′. In contrast thereto, a measured value v with T(v)=1 can be removed from the set V with a probability 1, i.e. cannot be transferred to or remain in a learning set V′.

The weighting function G can calculate a weight for each probability p, which is determined by T, of a measured value v. The weight of the associated measured value v can represent a value with which the measured value v should be weighted during the learning process/during the introduction in V′. For example, measured values having a high weight can have a relatively large influence on the model M. The weighting function can also be defined by G(p)=1−p.

The functions F, T and G can be defined both for individual measured values v and for a set of measured values V.

According to a further embodiment of the invention, the method further comprises the step of: determining whether or not the system S is in an error-free or an erroneous state.

Moreover, it is possible to determine for another set W of unmarked measured values w from the system S, for example at a later time point, whether the system S is in an error-free or erroneous state at the respective time point. This determination can be made by the learned model M and/or the rating system B.

According to a further embodiment of the invention, the score function F can be an independent, preferably machine learning system L′ and rating system B′ with output of a score value. Moreover, the score function F can be formed by considering the k next neighbors and/or the interquartile multiplying factor and/or the local outlier factor. Moreover, the score function F can form for each measured value v from the set V the distance to the closest neighbor, i.e. the minimum distance d(v) of the measured value v and divide it by the average distance m of all measured values v from V so that the following applies: F: V→Q, v [symbol] F(v)=d(v)/m=q. Moreover, the transformation function T can be a continuously increasing function, preferably with 0≦T(x)≦1 for all x∈ [symbol] , particularly preferably a normal distribution, a Weibull distribution, a beta distribution or a continuous equipartition. The weighting function G can be defined as G(p)=1−p=1−T(F(v)).

The continuously increasing function of the transformation function T can preferably have the characteristic 0≦T(x)≦1 for all x∈ [symbol] with T(−∞)≧0 and T(+∞)≦1.

Moreover, algorithms which can operate without knowing the underlying distribution of the measured values can be used for the score function F. The score function F can also have a Local Outlier Factor Algorithm or a Local Outlier Probability Algorithm.

According to a further embodiment of the invention, steps (b1) to (b3) can be carried out several times successively in an iterative manner.

By carrying out steps (b1) to (b3) several times successively in an iterative manner, the score function F, the transformation function T and the random removal of measured values from V and/or the weighting of measured values from V can be applied several times successively.

According to a further embodiment of the invention, the set V can be partitioned in step (a) into sub-sets V_1, . . . , V_N with N∈ [symbol] , and in step (b) modified learning sub-sets V_1′, . . . , V_N′ with N∈ [symbol] can be formed and the learning set V′ can be combined from the modified learning sub-sets V_1′, . . . , V_N′.

Accordingly, also in (b1) corresponding score value sets Q_1, . . . , Q_N with N∈ [symbol] can be formed from the sub-sets V_1, . . . , V_N by at least one score function F. Moreover, in (b2) corresponding probability sets P_1, . . . , P_N with N∈ [symbol] can be formed from the corresponding score value sets Q_1, . . . , Q_N by at least one transformation function T.

According to a further embodiment of the invention, in step (b) also at least one closest neighbor of the measured value v can be removed from the set V during removal and/or weighting of measured values v. The removal of the closest neighbors of the measured value v can be carried out in accordance with value and/or time criteria. For example, a closest neighbor can be removed which has a value being comparable to the measured value v or which comes very close to the measured value v. Furthermore, for example the closest neighbor can be selected in accordance with its temporal vicinity to the measured value. For example, the closest neighbor can have been measured simultaneously with or within a lime limit before or after the measured value to be actually removed.

According to a further embodiment of the invention, the measured values can be selected form the group comprising: capacity utilization of a calculating unit, used and free storage space, capacity utilization and state of input and output channels, number of error-free and erroneous packets, lengths of transmission queues, error-free and erroneous service inquiries, processing time of a service inquiry.

The invention also relates to a system for rating measured values taken from a system S that may be in an error-free or erroneous state, wherein the system S comprises at least one communication network, a network component of a communication system and/or a service of a communication network, comprising: a device for forming a set V of unmarked measured values v from the system S; a device for forming a modified learning set V′ comprising measured values v′ for a learning system L by removal and/or weighting of measured values from the set V using a random-based method; learning system L suitable for forming a model M for rating measured values from the system S from the modified learning set V′; and rating system B suitable for rating measured values from the system S using the model M.

According to a further embodiment of the invention, the device for forming a modified learning set V′ can comprise: a device for forming a score value set Q comprising score values q from the set V by at least one score function F: V→Q, v [symbol] F(v)=q; a device for forming a probability set P comprising probabilities p from the score value set Q by at least one transformation function T: Q→P, q [symbol] T(q)=T(F(v))=p.

device for forming the modified learning set V′ can be suitable for forming the modified learning set V′ from measured values by introducing the measured values v∈V with a corresponding probability of 1−p, with p=T(F(v)) into the modified learning set V′. Moreover, the device for forming the modified learning set V′ can be suitable for forming the modified learning set V′ from measured values by weighting the measured values v∈V by at least one weighting function G.

According to a further embodiment of the invention, the system for rating measured values taken from a system S can further comprise a device for determining whether the system S is in an error-free or in an erroneous state.

According to a further embodiment of the invention, the device for forming a score value set Q can be suitable for forming the score value set Q several times. Moreover, the device for forming a probability set P can be suitable for forming the probability set several times. Furthermore, the device for forming the modified learning set V′ can be suitable for forming the modified learning set V′ several times.

According to a further embodiment of the invention, the device for forming a set V from unmarked measured values v from the system S can be suitable for partitioning the set V into sub-sets V_1, . . . , V_N with N∈ [symbol] . Moreover, the device for forming a modified learning set V′ can be suitable for forming modified learning sub-sets V_1′, . . . , V_N′ with N∈ [symbol] and to combine the learning set V′ from the modified learning sub-sets V_1′, . . . , V_N′.

According to a further embodiment of the invention, the device for forming a modified learning set V′ can be suitable for removing also at least one closest neighbor of the measured value v from the set V during removal and/or weighting of measured values v.

The present invention provides a method for rating measured values taken from a system S which does not need threshold values and instead uses a randomized/random-based method. By using a randomized/random-based method, the user does not have to determine a threshold by means of involved tests and evaluations, and also measured values from the set V which deviate very much from the majority of the measured values but belong to a normal system state of S have a chance—according to the assigned probability—to be included in the learning set of measured values. In methods using threshold values, it is difficult or impossible to achieve this aim. The method according to the invention does not need knowledge about the underlying distributions of the measured values. However, if this knowledge is nevertheless completely or partly present, it can be used for the selection of the score function(s) F and transformation function(s) T. In contrast to prior art methods, in accordance with the present invention, probabilities calculated by the randomized method using the function T are used to form a learning set in a randomized manner. In this connection, not only the current learning set V can be important but also the possible behavior of the measured values from the system S therebeyond. The calculated probability values are not (only) used for making a list comprising outliers but they are used in a randomized method for determining a reduced learning set V′ from the original learning set V.

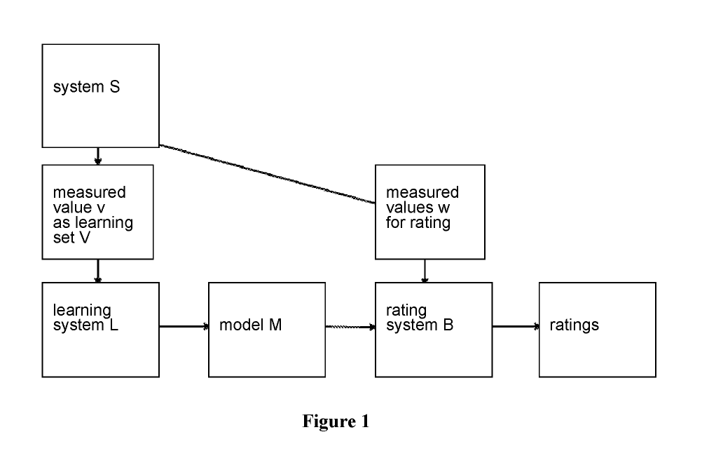

FIG. 1 shows a schematic view of a conventional method for rating measured values taken from a system S according to the prior art.

In a system S, for example a network, a set V of measured values v is taken. This set V should serve as a learning set for a learning system L. The measured values v from the set V are unmarked, i.e. no statement can be made as to whether the measured values v are erroneous or not, i.e. whether or not the system S is in an erroneous state while the measured values are taken.

Using a predetermined threshold value, the learning system L rates the set of measured values V or the measured values v. In the present case, measured values v lying below the threshold value are removed from the learning set and are not considered further. The thus determined learning set V′, which comprises only the measured values v above the threshold value, is used by the learning set L to form a model M. The model M is a representation of the error-free system S in view of the learned measured values. On the basis of the model M, a statement should be made for future, new measured values w as to whether or not the system S is in an erroneous state with respect to the new measured values w.

For this purpose, the model M is used for forming a rating system B. Then, the measured values w from the new set of measured values W to be evaluated are supplied to the rating system B. Subsequently, the rating system B rates the measured values w from the set of measured values W thereby taking into consideration the formed model M and makes a statement as to whether or not the measured values w are erroneous and, thus, whether or not the system is in an erroneous state.

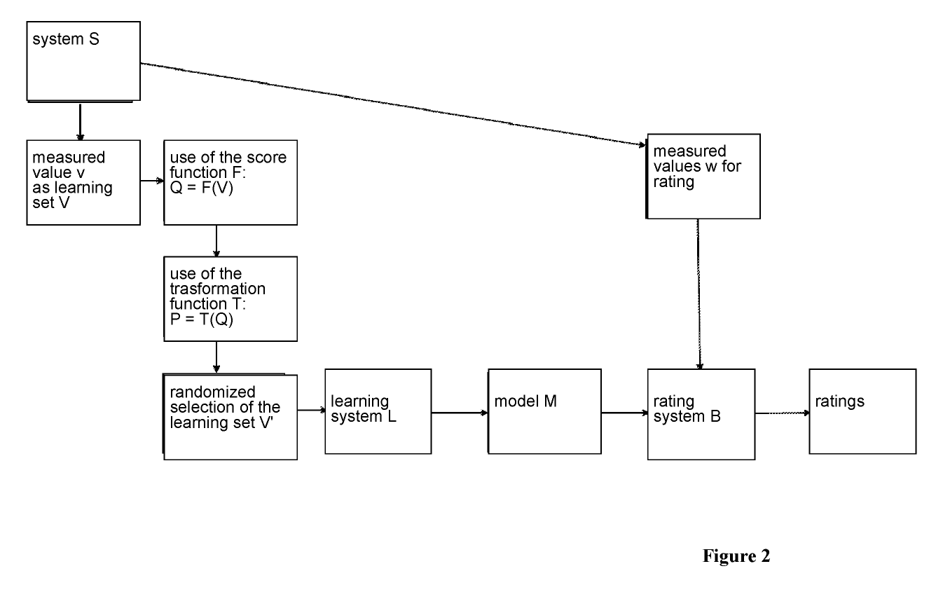

FIG. 2 shows a schematic view of a preferred embodiment of a method for rating measured values taken from a system S according to the present invention. In this preferred embodiment, measured values v are again taken in a system S and combined to a set of measured values v intended as learning set. A score function F is applied to the measured values v and thus a set of score values Q comprising score values q is formed. Then, a transformation function T is applied to this score value set Q and thus a probability set P comprising probabilities p is formed. By a randomized selection, then the modified learning set V′ of measured values is formed. The measured values v are included into the modified learning set V′ with a corresponding probability of 1−p. The measured values v can be given also (or only) a corresponding weighting by a suitable weighting function G and accordingly all measured values v G V are included with corresponding weightings into the modified learning set V′.

Then, by using the learning set V′, the learning system L forms a suitable model M, wherein the model M in turn is a representation of the error-free system S.

Then, a rating system B is formed by using the model M. Newly taken measured values w∈W from the system are provided to the rating system B and the rating system rates whether the new measured values w∈W are erroneous or normal and accordingly whether the system S is in an erroneous or in a normal state.

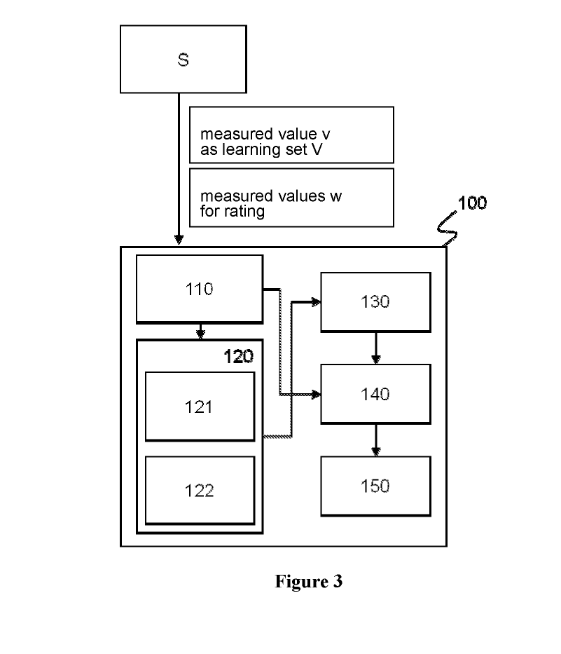

FIG. 3 shows a schematic view of a preferred embodiment of a system for rating measured values taken from a system S according to the present invention. The system 100 for rating measured values taken from a system S comprises a device 110 for forming a set V of unmarked measured values v from the system S, a device 120 for forming a modified learning set V′, a learning system L 130, a rating system B 140 as well as a device 150 for determining whether or not the system S is in an erroneous state.

The device 110 receives measured values v taken by the system S and, on the basis of these taken measured values, forms a set V of unmarked measured values v. Then, a modified learning set V′ comprising measured values v′ is formed in the device 120 as follows:

In the device 121, a score value set Q comprising the score values q is formed from the set V comprising the measured values v by means of a score function F. Then, in the device 121 a probability set P comprising probabilities p is formed from the score value set Q comprising the score values q by means of a transformation function T. Subsequently, in the device 120 the measured values v are included with a corresponding probability of 1−p with p=T(F(v)) into the modified learning set V′. Thus, a modified learning set V′ is obtained by randomization/random-based treatment of the originally taken set V.

Then, the modified learning set V′ is used in the learning system L 130 for forming a model M for the system S. The model M is a representation of the error-free system S.

Using this model M, it is then rated in the rating system B 140 whether the measured values w of a new measured value set W from the system to be evaluated are erroneous or not. The measured value set W comprising the measured values w to be evaluated can also have been formed or measured by the device 110. Then, it is determined in a device 150 on the basis of the rating of the measured values w whether the system S is in an error-free or in an erroneous state. The accordingly determined results as to whether the measured values w are erroneous or not or whether the system S is in an erroneous or an error-free state can then accordingly be further processed, e.g., in a further system.

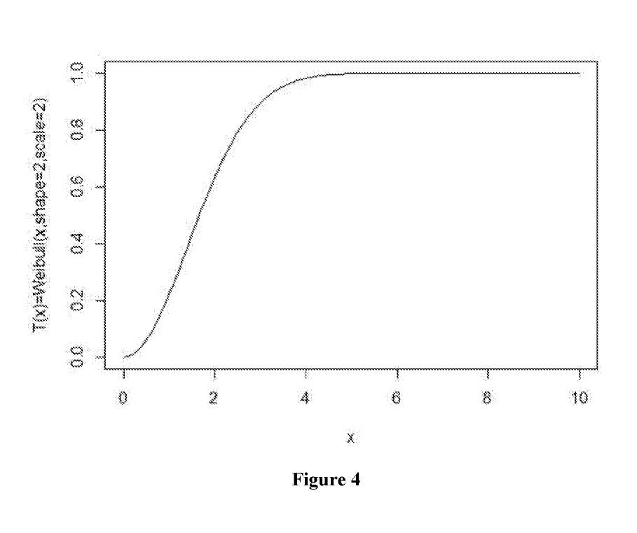

FIG. 4 shows a schematic view of a Weibull distribution, which is used as transfer function, of a preferred embodiment of a method for rating measured values taken from a system according to the present invention. In the presently described embodiment of the present invention, the following six measured values are measured for a specific measurand (type) at the system S and should later serve as input in the learning system L. The measured value set V of the measured values v is: V=(101, 102, 1, 100, 103, 105).

The third measured value v=1 is an outlier in the list of measured values. The learning system L, however, does not know whether the outlier is an erroneous or error-free measured value and whether this outlier was measured in an erroneous or error-free state of the system S.

If the learning system L formed for a learning set V as model M the minimum and the maximum of the measured values from V, the following would apply:
with the measured value v=1: minimum=1, maximum=105
without the measured value v=1: minimum=100, maximum=105

If the maximum and the minimum were used as model M for the description of the error-free system, in the present case two completely different realizations would be achieved depending on whether the measured value 1 were added or not. In the case minimum=1 and maximum=105 the range of acceptance for new measured values is larger than in the case minimum=100 and maximum=105.

In the first case, more measured values than normally would be accepted than in the second case.

Therefore, in the present example according to the invention, as score function F(v) rather the function is used which forms for each measured value v from V the distance to the closest measured value from V and divides them by the mean distance m of all measured values from V.

d(v) means the minimum distance of the measured value v from all other measured values. Thus, the following applies:
d(101)=1
d(102)=1
d(1)=99
d(100)=1
d(103)=1
d(105)=2

Hence, the mean distance m is then:
m=(1+1+99+1+1+2)/6=105/6=17.5

Using the score function F, the score values for the measured values from V can now be calculated:
F(101)=1/17.5≈0.057
F(102)=1/17.5≈0.057
F(1)=99/17.5≈5.65
F(100)=1/17.5≈0.057
F(103)=1/17.5≈0.057
F(105)=2/17.5≈0.11

According to the invention, these score values are then transformed to probabilities using a transfer function T. In accordance with the example according to the invention, the Weibull distribution with the parameters k=2, the so-called shape parameter, and X=2, the so-called scale parameter, is used as transfer function.

The Weibull distribution T is defined as follows:
x<0: T(x; k, lambda)=0.
x≧0: T(x; k, lambda)=(k/lambda) (x/lambda)̂(k−1) exp(−(x/lambda)̂k)
   wherein “̂” is the exponentiation and exp( ) is the exponential function.

FIG. 3 shows the Weibull distribution according to the present invention with these parameters.

The score values transformed by means of T are as follows:
F(101)=1/17.5≈0.057, T(0.057)=0.00081
F(102)=1/17.5≈0.057, T(0.057)=0.00081
F(1)=99/17.5≈5.65, T(5.65)=0.9996
F(100)=1/17.5≈0.057, T(0.057)=0.00081
F(103)=1/17.5≈0.057, T(0.057)=0.00081
F(105)=2/17.5≈0.11, T(0.057)=0.0030

On the basis of the calculated probability value, the individual measured values are now removed from or maintained in the learning set V in a randomized manner.

Thus, the measured values 101, 102, 100, 103, 105 are very probably maintained in V and the measured value 1 is removed. The modified learning set V′ thus comprises very probably the following measured values:
V′=(101, 102, 100, 103, 105)

Then, a suitable model M is formed by using the learning set V′, and subsequently a rating system B is formed by using the model M.

Newly taken measured values w∈W from the system can then be provided to the rating system B, and the rating system B can rate whether the new measured values w∈W are erroneous or normal and whether the system S is accordingly in an erroneous or a normal state.

Although the invention is illustrated on the basis of the FIGS. and described in detail on the basis of the corresponding description, this illustration and detailed description are to be understood as being illustrative and exemplary and not as restricting the invention. Skilled persons can of course make changes and amendments without leaving the scope and gist of the following claims. In particular, the invention also comprises embodiments including any combination of features mentioned or shown before or in the following in view of various embodiments.

The invention also comprises individual features in the figures even if they are shown therein in connection with other features and/or if they are not mentioned before or in the following. Furthermore, the alternatives of embodiments described in the figures and the description and individual alternatives and their features can be excluded from the subject-matter of the invention and/or the disclosed subject-matter. The disclosure comprises embodiments which comprise exclusively the features described in the claims and/or in the examples as well as also such embodiments which additionally comprise other features.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A method for rating measured values taken from a system S that may be in an error-free or erroneous state, wherein the system S comprises at least one communication network, a network component of a communication system or a service of a communication network, the method comprising:
(a) forming, by a device, a set V of unmarked measured values v from the system S;
(b) forming, by the device, a modified learning set V′ comprising measured values v′ for a learning system L by (i) removal or (ii) weighting or (iii) removal and weighting of measured values from the set V using a random-based method;
(c) forming, by the device, a model M for rating measured values from the system S by the learning system L from the modified learning set V′; and
(d) rating, by the device, measured values from the system S by a rating system B using the model M;
wherein step (b) further comprises removing at least one closest neighbor of the measured value v during (i) removal or (ii) weighting or (iii) removal and weighting of measured values v from the set V.

2: The method according to claim 1, wherein step (b) further comprises:
(b1) forming a score value set Q comprising score values q from the set V by at least one score function F: V→Q, v [symbol] F(v)=q;
(b2) forming a probability set P comprising probabilities p from the score value set Q by at least one transformation function T: Q→P, q [symbol] T(q)=T(F(v))=p; and
(b3) forming the modified learning set V′ from measured values, wherein the measured values v∈V are included with a respective probability of 1−p, with p=T(F(v)), into the modified learning set V′.

3: The method according to claim 1, wherein step (b) further comprises:
(b1) forming a score value set Q comprising score values q from the set V by at least one score function F: V→Q, V [symbol] F(V)=q;
(b2) forming a probability set P comprising probabilities p from the score value set Q by at least one transformation function T: Q→P, q [symbol] T(q)=T(F(v))=p; and
(b3) forming the modified learning set V′ from measured values, wherein the measured values v∈V are included with a respective probability of 1−p, with p=T(F(v)), into the modified learning set V′;
wherein the measured values v∈V are given a respective weighting by at least one weighting function G.

4: The method according to claim 2, wherein the method comprises steps (b1) to (b3) in the recited order.

5: The method according to claim 1, further comprising:
determining whether the system S is in an error-free or an erroneous state.

6: The method according to claim 2, wherein the score function F represents an independent learning system L′ and rating system B′ with output of a score value.

7: The method according to claim 2, wherein the score function F represents an independent machine learning system L′ and rating system B′ with output of a score value.

8: The method according to claim 2, wherein the score function F is formed by considering one or more of the following: the k next neighbors, the interquartile multiplying factor, the local outlier factor.

9: The method according to claim 2, wherein the transformation function T is a continuously increasing function.

10: The method according to claim 9, wherein the transformation function T is a continuously increasing function with 0≦T(x)≦ 1 for all x∈ [symbol] .

11: The method according to claim 9, wherein the transformation function T is a normal distribution, a Weibull distribution, a beta distribution or a continuous equipartition.

12: The method according to claim 3, wherein the weighting function G is defined as G(p)=1−p=1−T(F(v)).

13: The method according to any claim 2, wherein steps (b1) to (b3) are carried out several times successively in an iterative manner.

14: The method according to claim 1, wherein in step (a) the set V is partitioned in sub-sets V_1, . . . , V_N with N∈ [symbol] , and
wherein in step (b) modified learning sub-sets V_1′, . . . , V_N′ with N∈ [symbol] are formed and the learning set V is combined from the modified learning sub-sets V_1′, . . . , V_N′.

15. (canceled)

16: The method according to claim 1, wherein measured values are selected from the group consisting of: capacity utilization of a calculating unit, used and free storage space, capacity utilization and state of input and output channels, number of error-free or erroneous packets, lengths of transmission queues, error-free and erroneous service inquiries, processing time of a service inquiry.

17: A system for rating measured values taken from a system S that may be in an error-free or erroneous state, wherein the system S comprises at least one communication network, a network component of a communication system or a service of a communication system, the system comprising a processor and a non-transitory computer-readable medium having processor-executable instructions stored thereon, wherein execution of the processor-executable instructions by the processor facilitates the following:
forming a set Y of unmarked measured values v from the system S;
forming a modified learning set V′ comprising measured values v′ for a learning system L by (I) removal or (h) weighting or (in) removal and weighing of measured values from the set V using a random-based method;
forming a model M for rating measured values from the system S from the modified learning set V′; and
rating measured values from the system S using the model M.

18: The system according to claim 17, wherein forming the modified learning set V′ further comprises:
forming a score value set Q comprising score values q from the set V by at least one score function F: V→Q, v [symbol] F(v)=q; and
forming a probability set P with probabilities p from the score value set Q by at least one transformation function T: Q→P, q [symbol] T(q)=T(F(v))=p;
wherein forming the modified learning set V′ further comprises forming the modified learning set V′ of measured values by introducing the measured values v∈V with a corresponding probability of 1−p, with p−T(F(v)) into the modified learning set V′ and by weighting the measured values v∈V by at least one weighting function G; and
wherein forming the modified learning set V′ further comprises removing at least one closest neighbor of the measured value v from the set V during (i) removal, or (ii) weighting or (iii) removal and weighting of measured values v.

19: The system according to claim 17, wherein forming the modified learning set V′ further comprises:
forming a score value set Q comprising score values q from the set V by at least one score function F: V→Q, v [symbol] F(v)=q; and
forming a probability set P with probabilities p from the score value set Q by at least one transformation function T: Q→P, q [symbol] T(q)=T(F(v))=p; and
wherein forming the modified learning set V′ further comprises forming the modified learning set V′ of measured values by introducing the measured values v∈V with a corresponding probability of 1−p, with p=T(F(v)) into the modified learning set V′ and by weighting the measured values v∈V by at least one weighting function G.

20: The system according to claim 17, wherein execution of the processor-executable instructions by the processor further facilitates:
determining whether the system S is in an error-free or erroneous state.

21: The system according to claim 18, wherein execution of the processor-executable instructions by the processor further facilitates:
forming the score value set Q several times; and
forming the probability set P_several times; and
forming the modified learning set V′ several times.

22: The system according to claim 17, wherein forming the set V of unmarked measured values v from the system S further comprises partitioning the set V into sub-sets V_1, . . . , V_N with N∈ [symbol] , and
wherein forming the modified learning set V′ further comprises forming modified learning sub-sets V_1′, . . . , V_N′ with N∈ [symbol] .

23. (canceled)

24: The system according to claim 17, wherein measured values are selected from the group consisting of: capacity utilization of a calculating unit, used and free storage space, capacity utilization and state of input and output channels, number of error-free or erroneous packets, lengths of transmission queues, error-free and erroneous service inquiries, processing time of a service inquiry.
